(19) United States
(12) Patent Application Publication
(10) Pub. No.: US 2009/0107526 A1
(43) Pub. Date: Apr. 30, 2009

(54) CO2 SYSTEM FOR POLYMER FILM CLEANING

(76) Inventors: Jun ZHUGE, Union City, CA (US); Charles W. Bowers, Livermore, CA (US); Steven Askin, Trace, CA (US)

Correspondence Address: BOC, INC., 575 MOUNTAIN AVE, MURRAY HILL, NJ, 07974-2064, US

(21) Appl. No.: 12/261,157

(22) Filed: Oct. 30, 2008

Related U.S. Application Data
(60) Provisional application No. 61/001,329, filed on Oct. 31, 2007.

(51) Int. Cl. B08B 1/02; B08B 3/02; B08B 5/02

(52) U.S. Cl. 134/15; 134/151; 134/122 R; 134/57 R; 134/144; 134/115 R; 134/37; 134/34

(57) ABSTRACT

An apparatus and method for cleaning polymer film are provided and include a support assembly for supporting the polymer film to be cleaned, the support assembly being constructed and arranged to move the polymer film for cleaning, and at least one nozzle disposed adjacent the polymer film for providing CO₂ to the polymer film for dislodging particulate matter from the polymer film and the at least one aperture, and for cleaning thereof.

### BACKGROUND OF THE INVENTION

The present invention relates to polymer film cleaning.

Polymer films and webs have to date been cleaned with dionized (DIO) water, air megasonics, ultraviolet (UV) light, and combinations thereof to remove particles and debris from the polymer. However, such cleaning applications are not sufficient for purposes of medical devices using polymer films. This is especially so where polymer films have been provided with holes or apertures, and the area of the film surrounding such holes and apertures becomes clogged and contaminated with particles and remnants of the film when the holes are formed.

### BRIEF DESCRIPTION OF THE DRAWINGS

For a more complete understanding of the present invention, reference may be had to the following drawings taking in conjunction with the detailed description of the invention, of which:

FIGS. 1A and 1B are side and top views, respectively, of a polymer film having apertures therethrough at which debris and contaminates are at said apertures.

FIG. 1C shows the impact of debris laden and contaminated apertures upon fluid transfer through the apertures.

FIG. 2 shows a portion of an apparatus according to the invention for cleaning the polymer film.

FIG. 3 shows a portion of the apparatus of FIG. 2.

FIG. 4 is a view of a portion of the CO₂ cleaning apparatus of FIG. 2.

FIGS. 5A and 5B are side and top views, respectively, of the apertures having been cleaned by the system of FIGS. 2 and 6.

FIG. 5C shows the result of such cleaning upon fluid transfer through the apertures.

FIG. 6 shows another apparatus according to the invention for cleaning the polymer film.

### DETAILED DESCRIPTION OF THE PREFERRED EMBODIMENTS

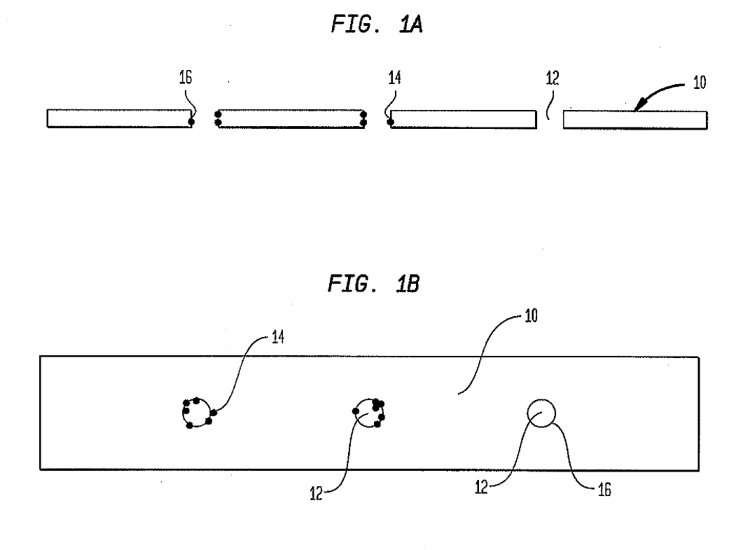

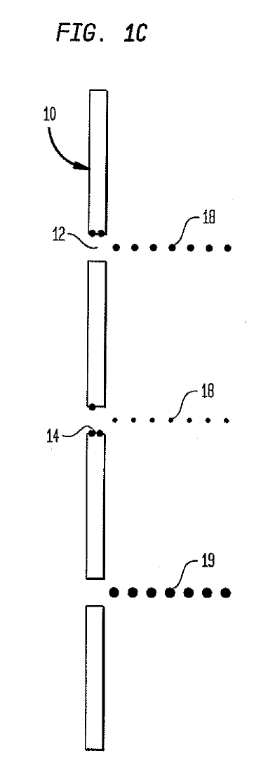

Referring to FIGS. 1A-1C, there is shown a polymer or polyimide film 10 or web which may be used in different processing and manufacturing applications. In particular, but only by way of example, the polymer film 10 may be used in the medical and health care industries. The film 10 may be used in medical devices, such as for example an insulin inhaler device. Accordingly, the film 10 is usually required to be of a clean and sterile construction.

As shown in FIGS. 1A and 1B, when the film 10 is formed or manufactured with one or a plurality of holes 12 or apertures therethrough, particulate matter and/or veils 14 may be formed or accumulate at edges 16 or a perimeter of the holes 12, thereby substantially reducing if not impeding a flow 18 of a fluid through the holes 12, as shown in FIG. 1C. Veils are the remnants of polymer disposed at the holes 12 when the holes are formed. Flow 19 is as a result of no veils or matter to impede fluid flow through the hole 12.

The holes shown in FIGS. 1A-1C usually range in size from microns to sub-microns. However, holes of different sizes in the polymer film may certainly be formed, depending upon the application of the polymer film 10.

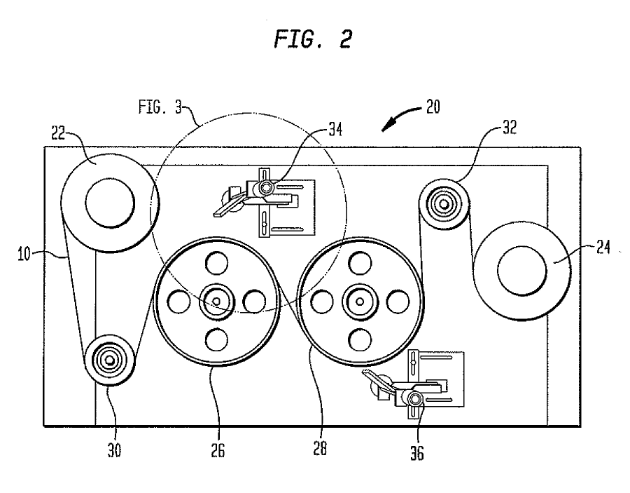

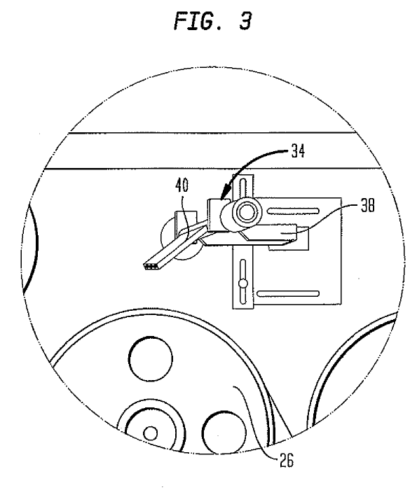

FIGS. 2 and 3 show a portion of an apparatus 20 according to the invention for transporting the polymer film 10 and cleaning thereof with CO₂. FIG. 2 shows the apparatus 20 having a plurality of reels, one of which is designated generally as a source reel 22; while another reel is designated generally as a take up reel 24 for the film 10. The film 10 already has the holes 12 formed therein and the source reel 22 of such film 10 is mounted to the apparatus 20, with the film 10 being fed over idler reels 26, 28, under a select tension for cleaning. Guide reels 30, 32 position the film 10 for movement with the idler reels 26, 28 to align the film for cleaning as discussed below.

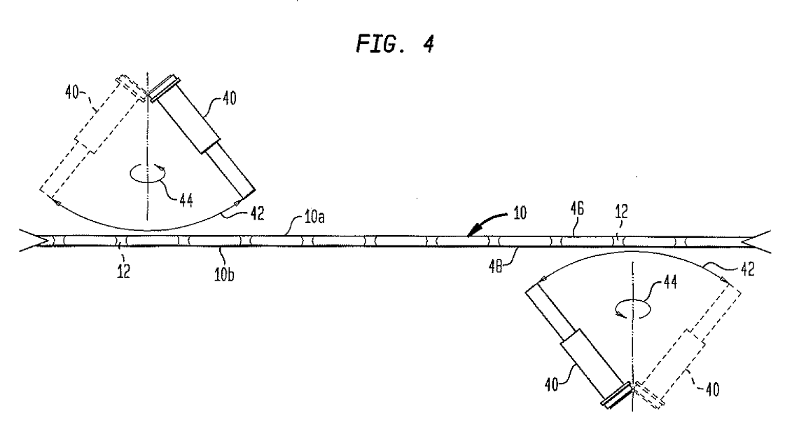

As shown in FIGS. 2 and 3, at least one or perhaps a plurality of CO₂ cleaning assemblies 34, 36 are disposed on the apparatus. The CO₂ cleaning assemblies 34, 36 each consist of moveable mounting members and nozzle assemblies for positioning nozzles with respect to the polymer film 10 for cleaning of same. As shown more particularly in FIGS. 2 and 3, mounting brackets 38 support CO₂ nozzles 40, which brackets 38 can be moved to a plurality of positions with respect to each other in order to move and adjust the nozzles 40 to a select position with respect to the polymer film 10 passing thereby for cleaning. Movement of the nozzles 40, as shown in FIG. 4 by arrows 42, 44 provide for the nozzles to be trained in a plurality of positions for effective cleaning by both nozzles 40 of opposed surfaces 10a, 10b of the polymer film 10. The opposed surfaces 10a, 10b may be cleaned either concurrently or sequentially. The arrow 42 shows the nozzle 40 being moved with respect to a longitudinal axis of the film 10. The arrow 44 shows the nozzle 40 being moved to track across a width of the film 10 for cleaning of the film.

Referring to FIG. 4, there is shown the polymer film 10 disposed for movement adjacent to at least one and perhaps a plurality of CO₂ nozzles 40. The film may be moved as between the source reel 22 and the take-up reel 24 as shown in FIG. 2. The film 10 may be moved under a high rate of speed and the nozzles 40 positioned at opposed surfaces 46, 48 of the film 10 for providing carbon dioxide (CO₂) in either pure or ultra-pure CO₂ snow form. Each one of the nozzles 40 is adapted for rotational movement as shown by the arrow 44 with respect to a surface of the film that passes the nozzle, and is adapted for angular movement as represented by the arrow 42 as well. The nozzles 10 may be of the single point or broad spray nozzle variety, such as those distributed by Eco-Snow Systems LLC of Livermore, Calif.

The apparatus 20 may be mounted in a hermetically sealed housing (a “clean box”) having a controlled atmosphere in a chamber of the box, such that dew point and temperature of the atmosphere are controlled for purposes of optimizing the cleaning, humidity control, sterilizing the environment and filtration of any particulars removed or sloughed-off from the film 10. The system of the present invention is adapted for use, for example, by pharmaceutical companies who use polymer film to make medical devices, which devices are used to control dosage of medicines.

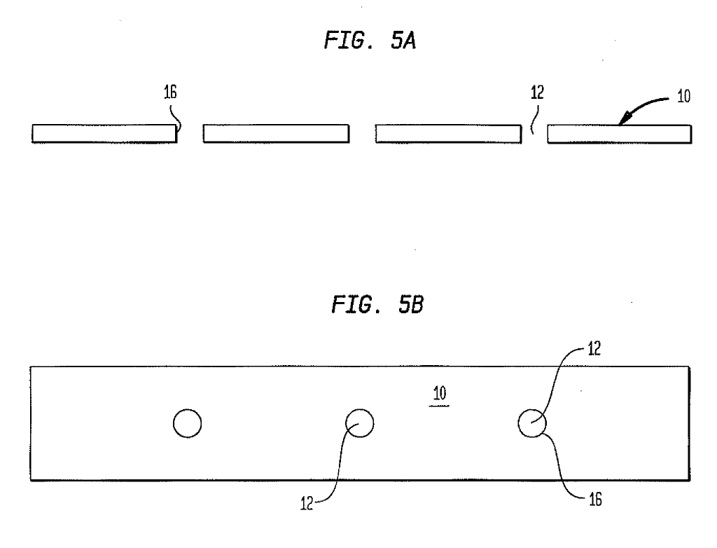

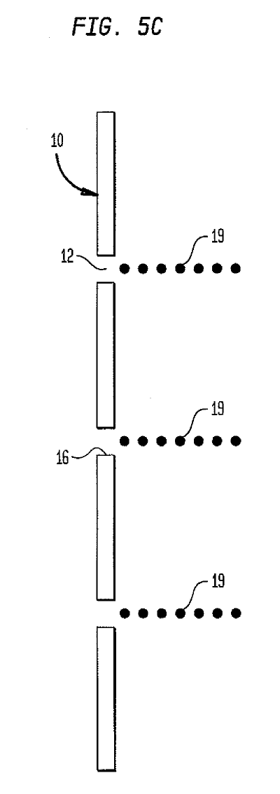

Referring now to FIGS. 5A-5C, it can be seen that the particulate matter, debris and veils have been removed by this CO₂ system of the present invention, thereby resulting in clean, clear apertures through which medicines or other fluid compositions may readily pass in an unimpeded flow 19 for subsequent use.

Use of purified CO₂ gas or liquid or a combination thereof does not contain any bacteria and particulate matter. No side effects to the patient or the film 10 should occur by use of such CO₂ on the polymer film. The high pressure of the CO₂ snow from the spray nozzle 40 will dislodge veils and particulate matter at the apertures without any detrimental effect or damage to the polymer film.

A filtration element can be employed in order to capture the particulate matter and veils that are dislodged during the cleaning process. The clean box process chamber temperature may be kept at about 60° C., by way of example only. Different types of film may require different cleaning temperatures and process conditions.

By way of example only, the nozzles 40 may be located one half inch (½″) from the film 10 surface (such as for example above the film surface 46), while the scan rate of the film is, for example, 100 mm/second. Different film types may require different scan rates for optimal cleaning of the film.

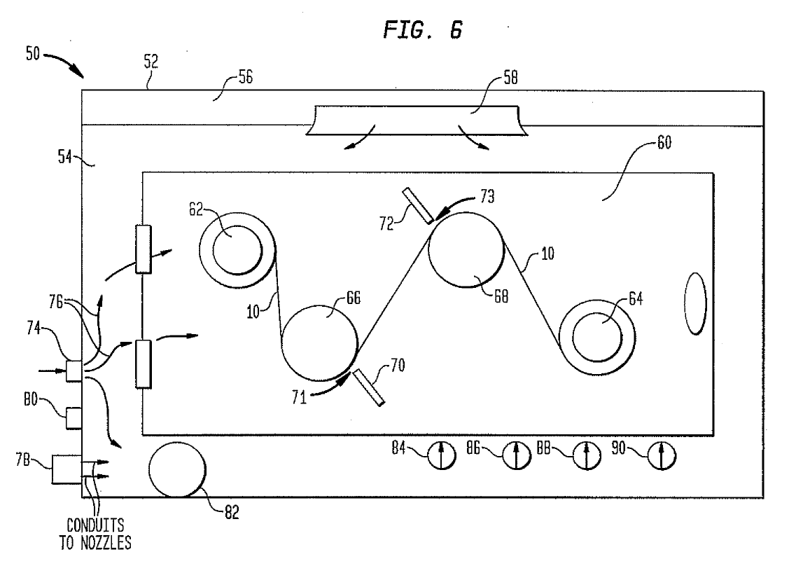

FIG. 6 shows an apparatus 50 according to the present invention for cleaning the polymer film 10. The apparatus 50 includes a housing 52 in which a chamber 54 is disposed therein. The chamber 54 includes sufficient amount of space for an air filter 56 and air blower 58 disposed in the chamber 54. A hinged glass door 60 provides access to the chamber 54.

Arranged within the chamber 54 is a plurality of drums; one of which is a supply drum 62, while the other of which is a motorized take-up reel 64. The supply drum 62 holds a supply of the polymer film 10 to be cleaned with the CO₂ spray. The supply drum 62 has a magnetic brake so as to tension the web or film 10 as it is drawn up by the motorized take-up reel 64. The tension applied to the polymer web or film 10 facilitates cleaning of the film. Idler wheels 66, 68 are disposed between the supply drum 62 and the take-up reel 64 to facilitate maintaining tension on the polymer film 10 and for the cleaning operation.

CO₂ nozzles 70, 72 are disposed to apply the CO₂ spray to the surface of the polymer film 10 to dislodge any contaminant material on the film and in particular which may be lodged in the apertures 12 formed in the film.

A conduit or passage 74 is provided in communication with the chamber 54 for the introduction of an inerting gas, such as clean dry air (CDA) or nitrogen (N₂), to be introduced into the chamber as shown by arrows 76. A passageway or conduit inlet 78 for the CO₂ is also in communication with the chamber 54 and through which CO₂ is provided from a CO₂ source (not shown) to the nozzles 40, 70, 72.

Power for the take-up reel 64 is provided from a power connector 80. An emergency off (EMO) switch 82 is also provided at an exterior of the housing 52. Indicators are provided for dew point 84 in the chamber 54, temperature 86 in the chamber, scan or rate 88 of speed of web, and distance 90 of the nozzle opening to the web in film 10 (in millimeters) are also provided in a faceplate of the housing 22.

The inerting gas introduced into the chamber 54 is to assist with reducing humidity in the chamber and for displacing a contaminant environment which may be proximate to the film 10 web to be cleaned. Air circulation within the chamber 54 is provided by the air blower 58. The air filter 56 is also disposed in the chamber 54, the air filter being removably mountable in order to change or clean same.

It will be understood that the embodiments described above are merely exemplary and that a person skilled in the art may make many variations and modifications without departing from the spirit and scope of the invention. All such variations and modifications are intended to be included within the present invention as described and claimed herein.

What is claimed is:

1. An apparatus for cleaning polymer film, comprising:
a support assembly for supporting the polymer film to be cleaned, the support assembly being constructed and arranged to move the polymer film for cleaning; and
at least one nozzle disposed adjacent the polymer film for providing CO₂ to the polymer film for cleaning thereof.

2. The apparatus according to claim 1, wherein the support assembly comprises a roller assembly, the roller assembly including a first spool for holding the polymer film to be cleaned and a second spool for holding the polymer film that has been cleaned.

3. The apparatus according to claim 2, further comprising at least one transport roller for moving the polymer film between the first spool and the second spool.

4. The apparatus according to claim 2, further comprising tension means for providing a select amount of tension to the polymer film for cleaning.

5. The apparatus according to claim 1, further comprising a housing for containing the support assembly and the at least one nozzle.

6. The apparatus according to claim 5, where the housing is constructed and arranged to be hermetically sealed.

7. The apparatus according to claim 5, further comprising temperature control means for controlling a temperature of the atmosphere in the housing.

8. The apparatus according to claim 5, further comprising humidity control means for controlling humidity of the atmosphere in the housing.

9. The apparatus according to claim 1, wherein the nozzle is adjustable with respect to the polymer film.

10. The apparatus according to claim 1, wherein the CO₂ is selected from CO₂ gas, CO₂ liquid, and combinations thereof.

11. The apparatus according to claim 1, wherein the polymer film is selected from non-treated films, metalized films and coated films.

12. The apparatus according to claim 1, further comprising an inerting gas provided proximate to the film.

13. The apparatus according to claim 12, wherein the inerting gas is selected from clean dry air, nitrogen, and combinations thereof.

14. A method of cleaning polymer film having at least one aperture therein, comprising:
supporting the polymer film to be moved for cleaning; and
providing CO₂ to the polymer film for dislodging particulate matter from the polymer film and the at least one aperture.

15. The method according to claim 14, wherein the CO₂ is selected from CO₂ gas, CO₂-liquid, and combinations thereof.

16. The method according to claim 14, wherein the providing CO₂ is from a spray nozzle.

17. The method according to claim 14, further comprising inerting an atmosphere proximate the polymer film with an inerting gas.

18. The method according to claim 17, wherein the inerting gas is selected from clean dry air, nitrogen, and combinations thereof.

19. The method according to claim 14, further comprising filtering the particulate matter dislodged from the polymer film and the at least one aperture.

20. A method of using CO₂ to clean a polymer film having at least one aperture therein, comprising providing CO₂ fluid to the polymer film for removing particulate matter and veils from the at least one aperture and the polymer film.
